(19) United States
(12) Patent Application Publication
(10) Pub. No.: US 2009/0092189 A1
(43) Pub. Date: Apr. 9, 2009

(54) MOVEMENT PREDICTION METHOD AND MOVEMENT PREDICTION APPARATUS

(76) Inventors: Toshiharu Tsuchiya, Kanagawa (JP); Toru Wada, Kanagawa (JP)

Correspondence Address: FROMMER LAWRENCE & HAUG LLP, 745 FIFTH AVENUE, NEW YORK, NY, 10151, US

(21) Appl. No.: 12/244,116

(22) Filed: Oct. 2, 2008

(30) Foreign Application Priority Data
Oct. 3, 2007 (JP) P2007-259966

(51) Int. Cl. H04N 7/26

(52) U.S. Cl. 375/240.16; 375/E07.123

(57) ABSTRACT

Disclosed herein is a movement-prediction/compensation method for carrying out processing based on search layers to search for a movement vector by selecting one or more reference frame images for each of movement-compensated blocks obtained as a result of dividing a processed frame image existing among successive frame images. The method includes: a layer creation step; a first movement-prediction/compensation step; a reference frame image determination step; and a second movement-prediction/compensation step.

### CROSS REFERENCES TO RELATED APPLICATIONS

The present invention contains subject matter related Japanese Patent Application JP 2007-259966 filed in the Japan Patent Office on Oct. 3, 2007, the entire contents of which being incorporated herein by reference.

### BACKGROUND OF THE INVENTION

1. Field of the Invention

The present invention relates to a movement prediction method and a movement prediction apparatus. For example, the present invention can be well applied to an image-information coding apparatus and an image-information decoding apparatus used for processing a received bit stream of image information transmitted through communication means or used for processing image information already stored in a storage medium such as an optical disk, a magnetic disk or a flash memory. The image information to be processed is typically information conforming to the MPEG (Moving Picture Experts Group) system or H.26x system used for compressing information by adoption of a movement compensation technique and an orthogonal transformation technique such as the discrete cosine transformation or the Karhunen-Loeve transformation. The communication means can be satellite broadcasting or network media such as a cable television, the Internet or the hand-held phone.

2. Description of the Related Art

In recent years, image information is processed as digital information. An apparatus conforming to the MPEG compression system or the like has been becoming popular as both apparatus for distributing information from broadcasting stations or the like and apparatus for receiving the distributed information at homes. In processing carried out by the apparatus to process the image information as digital information, in order for the apparatus to be able to transmit and store the information with a high degree of efficiency, a redundancy characteristic inherent in the image information is utilized in order to compress the image information by adoption of a movement compensation technique and an orthogonal transformation technique such as the discrete cosine transformation in accordance with the MPEG system.

In particular, an MPEG2 (ISO/IEC 13818-2) system is defined as a general image coding system. Covering both interlace scan images and sequential scan images as well as standard-resolution and high-definition images, the MPEG2 system is used in a wide range of applications including professional and consumer applications. In accordance with the MPEG2 compression system, typically, a code quantity (or a bit rate) in the range 4 to 8 Mbps is assigned to a standard-resolution interlace scan image having 720×480 pixels whereas a code quantity in the range 18 to 22 Mbps is assigned to a high-definition interlace scan image having 1,920×1,088 pixels. By assigning code quantities in this way, a high compression ratio and a high image quality can be realized.

The MPEG2 is mainly targeted at high image quality coding suitable for broadcasting. Thus, the MPEG2 is not intended for a coding system with a code quantity (or a bit rate) lower than that of an MPEG1, that is, a compression system with a compression ratio higher than that of the MPEG1. As the hand-held terminal becomes popular, however, in the future, the need for such coding system conceivably rises. In order to meet such a need, an MPEG4 coding system has been standardized. Specifications of the image coding system have been approved as an international standard called ISO/IEC 14496-2 in December 1998.

In addition, in recent years, an effort to make specifications of an H.26L (ITU-TQ6/16 VCEG) standard targeted at image encoding processes for television conferences has been making progress during initial phases. In comparison with the hitherto known standards such as MPEG2 and MPEG4, even though the H.26L standard entails a large amount of processing such as encoding and decoding processes thereof, the H.26L standard is known as a standard for realizing an encoding efficiency (a compression ratio) higher than the hitherto known standards. In addition, as part of activities related to the MPEG4 system, at the present day, functions not supported by the MPEG4 system are brought in with the H.26L standard taken as a base in order to produce a standard for realizing an even higher encoding efficiency. These standardization activities are carried out as activities of Joint Model of Enhanced-Compression Video Coding. In accordance with the schedule of the standardization activities, an international standard was completed in March 2003, being named H.264 and MPEG-4 Part 10 (Advanced Video Coding: abbreviated in the following description to AVC).

FIG. 1 is a block diagram showing a typical configuration of an image-information coding apparatus 100 for generating image information compressed in accordance with the AVC specifications.

As shown in the block diagram of FIG. 1, the image-information coding apparatus 100 employs: an A/D conversion section 101 supplied with an input image signal, converting the signal into digital image data; an image rearrangement buffer 102 used for storing the digital image data output by the A/D conversion section 101; an adder 103 supplied with an image data read out from the image rearrangement buffer 102; an intra-prediction section 112; a movement-prediction/compensation section 113; an orthogonal transformation section 104 supplied with outputs by the adder 103, intra-prediction section 112 and movement-prediction/compensation section 113; a quantization section 105 supplied with an output by the orthogonal transformation section 104; a lossless encoding section 106 and an inverse quantization section 108 each supplied with an output by the quantization section 105; an accumulation buffer 107 supplied with an output by the lossless encoding section 106; an inverse orthogonal transformation section 109 supplied with an output by the inverse quantization section 108; a de-block filter 110 supplied with an output by the inverse orthogonal transformation section 109; a frame memory 111 supplied with an output by the de-block filter 110; and a rate control section 114. The image rearrangement buffer 102 is a memory.

In this image-information coding apparatus 100, first of all, the A/D conversion section 101 converts an input image signal into a digital signal. Then, on the basis of a GOP (Group of Pictures) structure of image compressed information to be output, in the image rearrangement buffer 102, frames of the digital signal output by the A/D conversion section 101 are rearranged.

In the case of an image to be subjected to an intra-coding process, the adder 103 provides the orthogonal transformation section 104 with image information obtained as a result of subtracting information output by the intra-prediction section 112 as information on differences between pixel values from the input image information read out from the image rearrangement buffer 102. The orthogonal transformation section 104 then carries out orthogonal transformation processing on the image information received from the adder 103. The orthogonal transformation processing is typically a discrete cosine transformation process or a Karhunen-Loeve transformation process. Then, the quantization section 105 carries out a quantization process on transformation coefficients generated by the orthogonal transformation section 104 as a result of the orthogonal transformation processing. Subsequently, the lossless encoding section 106 carries out lossless encoding processing on quantized transformation coefficients generated by the quantization section 105 as a result of the quantization process. The lossless encoding processing includes a variable-length encoding process and an arithmetic encoding process. Data output by the lossless encoding section 106 is then stored in the accumulation buffer 107 to be eventually output as image compressed information. The quantization process performed by the quantization section 105 is controlled by the rate control section 114 on the basis of a signal output by the accumulation buffer 107 to the rate control section 114. The quantized transformation coefficients generated by the quantization section 105 are also supplied to the inverse quantization section 108 at the same time. Then, the inverse quantization section 108 carries out an inverse quantization process on the quantized transformation coefficients output by the quantization section 105. Subsequently, the inverse orthogonal transformation section 109 carries out an inverse orthogonal transformation process on data output by the inverse quantization section 108 in order to generate decoded image information which is then supplied to the de-block filter 110. The de-block filter 110 carries out a filtering process to remove block distortions from the decoded image information and then stores the result in the frame memory 111. The intra-prediction section 112 reads out the image information from the frame memory 111 and carries out an intra-prediction process on the image information. The intra-prediction section 112 then supplies the aforementioned information to the adder 103. The intra-prediction section 112 also provides the lossless encoding section 106 with information on an intra-prediction mode applied to the blocks/macro-blocks of the image information subjected to the intra-prediction process. The lossless encoding section 106 then carries out an encoding process on the information on an intra-prediction mode by handling the information as a portion of the header of the image compressed information.

As for an image to be subjected to an inter-encoding process, first, the image information is supplied to the movement-prediction/compensation section 113. At the same time, reference image information is fetched from the frame memory 111 and subjected to a movement-prediction/compensation process, whereby reference image information is generated. The reference image information is sent to the adder 103, here converted to a difference signal representing difference with the input image information. At the same time, the movement-prediction/compensation section 113 also supplies movement vector information to the lossless encoding section 106. Subsequently, the lossless encoding section 106 carries out the lossless encoding processing such as a variable-length coding process and an arithmetic coding process in order to generate information to be inserted into the header of the image compressed information. The remaining processes are the same as those described previously as the processes carried out on an image to be subjected to the intra-coding processing.

FIG. 2 is a block diagram showing a typical configuration of an image-information decoding apparatus 150 for decompressing a compressed image by carrying out movement compensation processing and orthogonal transformation processing such as a discrete cosine transformation process or a Karhunen-Loeve transformation process.

As shown in the block diagram of FIG. 2, the image-information decoding apparatus 150 includes: an accumulation buffer 115 supplied with image compressed information; a lossless decoding section 116 to which the image compressed information read out from the accumulation buffer 115 is supplied; an inverse quantization section 117 supplied with an output by the lossless decoding section 116; an inverse orthogonal transformation section 118 supplied with an output by the inverse quantization section 117, an adder 119 supplied with an output by the inverse orthogonal transformation section 118, an image rearrangement buffer 120 and a frame memory 122 each supplied with an output by the adder 119, a D/A conversion section 121 supplied with an output by the image rearrangement buffer 120, a movement-prediction/compensation section 123 and a intra-prediction section 124 supplied with an output by the frame memory 122; and a de-block filter 125 through which the output by the adder 119 is supplied to the image rearrangement buffer 120.

In the image-information decoding apparatus 150, first of all, input image compressed information is stored in the accumulation buffer 115. Then, the lossless decoding section 116 reads out the image compressed information from the accumulation buffer 115. The lossless decoding section 116 carries out processing including a variable-length decoding process and an arithmetic decoding process on the image compressed information in accordance with the determined format of the information. If the frame of the image compressed information is a frame obtained as a result of an intra-coding process, the lossless decoding section 116 also decodes intra-prediction mode information included in the header of the image compressed information at the same time and supplies the result to the intra-prediction section 124. If the frame is obtained as a result of an inter-coding process, on the other hand, the lossless decoding section 116 also decodes movement vector information included in the header of the image compressed information at the same time and supplies the result to the movement-prediction/compensation section 123.

Quantized transformation coefficients obtained as the main output of the lossless decoding section 116 are supplied to the inverse quantization section 117 which outputs transformation coefficients. The inverse orthogonal transformation section 118 carries out a fourth-order inverse orthogonal transformation process based on a determined method on the transformation coefficients.

If the frame is obtained as a result of an intra-coding process, the adder 119 adds the image information received from the inverse orthogonal transformation section 118 to information generated by the intra-prediction section 124 and supplies a sum obtained as a result of the addition process to the de-block filter 125. The de-block filter 125 removes block distortions from the sum and stores image information without block distortions in the image rearrangement buffer 120. Finally, the D/A conversion section 121 reads out digital image information from the image rearrangement buffer 120 and converts the information into an analog image signal as the output of the image-information decoding apparatus 150.

If the frame of the image compressed information is obtained as a result of an inter-coding process, based on decoded movement vector information obtained as a result of the lossless decoding process and image information stored in the frame memory 122, a reference image is generated. The reference image is added with the output by the inverse orthogonal transformation section 118 at the adder 119. The remaining processes are the same as that in the case of an intra-coding process.

By the way, in the image-information coding apparatus 100 shown in the block diagram of FIG. 1, the movement-prediction/compensation section 113 performs an important role in realization of a high compression ratio. By introducing three methods described below in an AVC encoding system, it is possible to realize a high compression ratio in comparison with the ratio provided by an image coding system such as the hitherto known MPEG2.4 system. The first one of the three methods is a multiple reference frame method, the second one of the three methods is a variable movement-prediction/compensation block size method and the third one of the three methods is a ¼-pixel precision movement compensation method making use of a FIR (Finite Impulse Response) filter.

First of all, the multiple reference frame method prescribed by the AVC encoding system is described as follows.

In the AVC system, for each movement-compensated block of a processed frame, it is possible to select a reference frame or reference frames to be used as a frame including a reference block for the movement-compensated block or reference frames each including such a reference block among a plurality of reference frames as shown in a diagram of FIG. 3.

This means, for example, even if the immediately preceding frame does not have a block to be referred to, it is possible to prevent the coding efficiency from declining due to occlusion caused by the inexistence of such a reference block on the immediately preceding frame.

In addition, with a flash existing on an image serving as a reference, the coding efficiency substantially becomes worse if the frame of the image is used as a reference frame. Also in this case, however, by selecting a frame or frames from a plurality of preceding frames as a reference frame or reference frames, it is possible to prevent the coding efficiency from declining.

Next, the variable block size method prescribed by the AVC encoding system is described as follows.

As shown in a diagram of FIG. 4, in the AVC encoding system, a macro-block can be divided into 8×8 smallest movement-compensated blocks. On top of that, each of the 8×8 movement-compensated blocks can be further divided into smallest 4×4 subpartitions. Each movement-compensated block in every macro-block can have its own movement vector information.

Next, the ¼-pixel precision movement compensation method prescribed by the AVC encoding system is described as follows.

By referring to a diagram of FIG. 5, the following description explains a ¼-pixel precision movement compensation process.

The AVC encoding system defines a six-tap FIR filter having filter coefficients shown in equation (1) given below as a filter for generating a pixel value with a ½ pixel precision.

### [Equation 1]

{1, −5, 20, 20, −5, 1} (1)

With regard to a movement compensation process (or an interpolation process) for finding pixel values b and h shown in the diagram of FIG. 5, a product-sum operation making use of the filter coefficients given in equation (1) as shown in equation (2) is carried out.

### [Equation 2]

b=(E−5F+20G+20H−5H+J)

h=(A−5C+20G+20M−5R+T) (2)

Then, a process expressed by equation (3) is carried out.

### [Equation 3]

b=Clip1((b+16)>>5)

h=Clip1((h+16)>>5) (3)

Notation Clip1 used in the above equations denotes a clip process carried out between (0, 255). Notation >>5 used in the above equations denotes a right shift operation by 5 bits, that is, a division operation making use of a divisor of 2⁵.

As for a pixel value j, first of all, pixel values aa, bb, cc, dd, ee, ff, gg and hh are found. Then, as shown in equation (4), the pixel value j is computed and, finally, a clip process shown in equation (5) is carried out in the same way for finding pixel values b and h.

### [Equation 4]

j=cc−5dd+20h+20m−5ee+ff, or

j=aa−5bb+20b+20s−5gg+hh (4)

### [Equation 5]

j=Clip1((j+512)>>10) (5)

As shown in equation (6) given below, pixel values a, c, d, n, f, i, k and q are found by making use of a linear interpolation process based on a pixel value with a multiple-pixel precision and a pixel value with a ½-pixel precision.

### [Equation 6]

a=(G+b+1)>>1

c=(H+b+1)>>1

d=(G+h+1)>>1

n=(M+h+1)>>1

f=(b+j+1)>>1

i=(h+j+1)>>1

k=(j+m+1)>>1

q=(j+s+1)>>1 (6)

As shown in equation (7) given below, each of pixel values e, g and p is found by making use of a linear interpolation process based on a pixel value with a ½-pixel precision.

### [Equation 7]

e=(b+h+1)>>1

g=(b+m+1)>>1

p=(h+s+1)>>1 (7)

For more information, refer to Japanese Patent Laid-open No. 2004-56827.

### SUMMARY OF THE INVENTION

By the way, with the image encoding apparatus 100 shown in the block diagram of FIG. 1, a large amount of processing needs to be carried out in order to search for a movement vector. How to reduce the amount of processing to be carried out in order to search for a movement vector while minimizing the deterioration in image quality is key to construction of an apparatus capable of carrying out real-time operations.

In the AVC encoding system, however, the multiple reference frame method, the variable movement-prediction/compensation block size method and the ¼-pixel precision movement compensation method are allowed. Thus, if the number of candidate reference frames increases, a refinement process in the movement-prediction/compensation processing undesirably becomes heavier.

In addition, if an image encoding apparatus implemented by H/W (hardware) is taken into consideration, a movement search process is carried out for all block sizes in a macro-block for every reference frame. Thus, since the number of accesses to a memory increases, it becomes necessary to raise the memory band in some cases.

By the way, with the image-information coding apparatus 100 shown in the block diagram of FIG. 1, a large amount of processing needs to be carried out in order to search for a movement vector. How to reduce the amount of processing to be carried out in order to search for a movement vector while minimizing the deterioration in image quality is key to construction of an apparatus capable of carrying real-time operations.

In order to solve the problems described above, inventors of the present invention have earlier proposed an image-information coding apparatus 200 having a configuration like one shown in a block diagram of FIG. 6.

As shown in the block diagram of the figure, the image-information coding apparatus 200 employs an A/D conversion section 201, an image rearrangement buffer 202, an adder 203, an orthogonal transformation section 204, a quantization section 205, a lossless encoding section 206, an accumulation buffer 207, an inverse quantization section 208, an inverse orthogonal transformation section 209, a de-block filter 210, a full-resolution frame memory 211, a pixel skipping section 212, a 1/N²-resolution movement-prediction/compensation section 214, reference frame determination section 215, a 1/N²-resolution frame memory 213, an intra-prediction section 216, a full-resolution movement-prediction/compensation section 217 and a rate control section 210.

Differences between the image-information coding apparatus 100 shown in the block diagram of FIG. 1 and the image-information coding apparatus 200 shown in the block diagram of FIG. 6 are the principles of operations carried out by the pixel skipping section 212, the 1/N²-resolution frame memory 213, the 1/N²-resolution movement-prediction/compensation section 214, and the full-resolution movement-prediction/compensation section 217. Hereinafter, the principles of the operations carried out by these components are explained as follows.

First of all, the principle of the operation carried out by the pixel skipping section 212 is described by referring to a diagram of FIG. 7. The pixel skipping section 212 reads out image information from the full-resolution frame memory 211 and carries out a 1/N pixel skipping process in both the horizontal and vertical directions on the image information in order to generate pixel values which are then stored in the 1/N²-resolution frame memory 213.

The 1/N²-resolution movement-prediction/compensation section 214 carries out a block matching process on 8×8 blocks or 16×16 blocks by making use of pixel values stored in the 1/N²-resolution frame memory 213 as pixel values of the blocks in order to search for optimum movement vector information for the matching blocks. In the block matching process, a predicted energy is computed not by making use of all pixel values. Instead, the predicted energy is computed by making use of pixel values specified on a grid like one shown in a diagram of FIG. 8.

In a process to carry out a field encoding process on the picture, a pixel skipping process shown in the diagram of FIG. 7 is carried out by dividing the picture into first and second fields.

The movement vector information found by using a contracted image as described above is supplied to the full-resolution movement-prediction/compensation section 217. For example, for N=2, in the case of 8×8 blocks used as the unit of the search operation, the 1/N -resolution movement-prediction/compensation section 214 sets 16×16 blocks for one macro block. In the case of 16×16 blocks used as the unit of the search operation, on the other hand, the 1/N²-resolution movement-prediction/compensation section 214 sets 16×16 blocks for four macro blocks. However, the full-resolution movement-prediction/compensation section 217 searches a very small range centered at these 16×16 movement vectors for all pieces of movement vector information which are defined as shown in the diagram of FIG. 4. By carrying out a movement prediction process for a very small search range on the basis of movement vector information found on the contracted image in this way, it is possible to substantially reduce the amount of processing carried out in order to search for movement vector information while minimizing the deterioration in image quality.

A reference frame or reference frames for each movement-compensated block are determined as follows.

The 1/N²-resolution movement-prediction/compensation section 214 detects a movement vector for each candidate reference frame. The full-resolution movement-prediction/compensation section 217 carries out a refinement process on a movement vector detected for each candidate reference frame. Then, a reference frame that minimizes a residual energy or some kind of cost function is selected as the reference frame.

By the way, in the AVC encoding system, the multiple reference frame method, the variable movement-prediction/compensation block size method and the ¼-pixel precision movement compensation method are allowed. Thus, if the number of candidate reference frames increases, the refinement process carried out by the full-resolution movement-prediction/compensation section 217 undesirably becomes heavier.

In addition, if an image encoding apparatus implemented by H/W (hardware) is taken into consideration, a movement search process is carried out for all block sizes in a macro-block for every reference frame. Thus, since the number of accesses to a memory increases, it becomes necessary to raise the memory band in some cases.

In order to solve the problems described above, as disclosed earlier in Japanese Patent Laid-open No. 2004-191937, inventors of the present invention have proposed an image-information coding apparatus 300 having a configuration like one shown in a block diagram of FIG. 9 wherein, in a process carried out on the basis of search layers to search for a movement vector by selecting a reference frame image including a reference block associated with one of movement-compensated blocks obtained as a result of dividing a processed frame image existing among successive frame images or by selecting two or more reference frame images each including such a reference block among a plurality of reference frame images for each of the movement-compensated blocks:

a pixel skipping section carries out a pixel skipping process on pixels of the movement-compensated block with a largest pixel size deserving a position on the uppermost-level search layer among pixel sizes of the movement-compensated blocks in order to generate a contracted image at a contraction ratio determined in advance on a low-level search layer;

a reference frame determination section determines a contracted reference image on the contracted image;

a 1/N²-resolution movement-prediction/compensation section searches for a movement vector by making use of the contracted image generated by the pixel skipping section; and

a full-resolution movement-prediction/ compensation section carries out a movement prediction process for a prior-contraction image by searching for a movement vector by making use of a predetermined range specified by the movement vector found by the 1/N²-resolution movement-prediction/compensation section.

As shown in the block diagram of FIG. 9, the image-information coding apparatus 300 employs an A/D conversion section 301, an image rearrangement buffer 302, an adder 303, an orthogonal transformation section 304, a quantization section 305, a lossless encoding section 306, an accumulation buffer 307, an inverse quantization section 308, an inverse orthogonal transformation section 309, a de-block filter 310, a full-resolution frame memory 311, the pixel skipping section 312, a 1/N²-resolution frame memory 313, the 1/N²-resolution movement-prediction/compensation section 314, the reference-frame determination section 315, an intra-prediction section 316, the full-resolution movement-prediction/compensation section 317 and a rate control section 318.

Differences between the image-information coding apparatus 200 shown in the block diagram of FIG. 6 and the image-information coding apparatus 300 shown in the block diagram of FIG. 9 are the principles of operations carried out by the reference-frame determination section 315, the 1/N²-resolution movement-prediction/compensation section 314 and the full-resolution movement-prediction/compensation section 317. Thus, only the principles of the operations carried out by the reference-frame determination section 315, the 1/N²-resolution movement-prediction/compensation section 314 and the full-resolution movement-prediction/compensation section 317 are explained as follows.

FIG. 10 is a diagram referred to in explanation of a typical concrete field encoding process. In this typical field encoding process, the processed field is the bottom field of a B picture whereas the reference fields are two fields on the forward (List0) side and two fields on the backward (List1) side. The contraction ratio N of the 1/N²-resolution frame memory 313 is 4.

In the case of the hitherto known image-information coding apparatus 100, in a block matching process carried out for each reference field, the 1/N²-resolution movement-prediction/compensation section 314 computes an optimum movement vector whereas the full-resolution movement-prediction/compensation section 317 carries out a refinement process for all block sizes with the movement vector taken as a center. In this way, a reference field or reference fields are determined for each list.

On the other hand, the reference-frame determination section 315 employed in the image-information coding apparatus 300 determines a reference field in accordance with a method explained by referring to a diagram of FIG. 11 at steps S101 to S111 of a flowchart shown in FIG. 12.

At a contraction ratio of ¼ shown in the diagram of FIG. 10, the 1/N²-resolution movement-prediction/compensation section 314 ( 1/16-resolution) takes a block-matching unit consisting of 16×16 blocks as shown in a diagram of FIG. 11A. In this case, the full-resolution movement-prediction/compensation section 317 sets a single movement vector pointing to 4×4 (=16) macro-blocks like the ones shown in FIG. 11A.

Then, the image-information coding apparatus 300 divides the block-matching unit consisting of 16×16 blocks into bands each consisting of 16×4 blocks as shown in a diagram of FIG. 11B. In the block matching process carried out on the 16×16 blocks, the 1/N²-resolution movement-prediction/compensation section 314 (where N=4) keeps an energy (SAD) for each of bands each consisting of 16×4 blocks. A band corresponds to a field described earlier.

That is to say, when setting the values of four indexes (BlkIdx) each indicating one of the four bands at 0 to 3 with the index 0 assigned to the top band, for each of the reference fields, it is possible to obtain an energy SAD_ListX[refIdx][BlkIdx] according to an equation given below.

### [Equation 8]

For ListX (X=0, 1)

SAD_ListX[refIdx][BlkIdx]

(BlkIdx=0 to 3) (8)

In the above equation, notation SAD_ListX[refIdx][BlkIdx] denotes an energy SAD which is stored for each value of the index BlkIdx as an energy for an optimum movement vector found in 16×16 block matching process for every value of the index refIdx of each list.

In addition, the 16×16 block matching processes result in optimum movement vectors MV_ListX[refIdx] (that is, optimum movement vectors MV_List0 [0], MV_List0 [1], MV_List1 [0], and MV_List1 [1]).

In this process, the reference-frame determination section 315 compares residual energies, which are each associated with an index BlkIdx indicating a field on a frame on a list, with each other in accordance with the following equation in order to determine a smallest energy reference field as a reference field having 16×4 blocks.

### [Equation 9]

For ListX (X=0, 1)

refIdx[BlkIdx]=MIN (SAD_ListX[refIdx][BlkIdx])

(BlkIdx=0 to 3) (9)

In addition, a movement vector MV[List][refIdx] is also determined for a smallest energy found out for every value of the index refIdx.

A flowchart shown in FIG. 12 represents the flow of the processing described above.

Then, by carrying out refinement processing only on the surroundings of an area pointed to by a determined movement vector, it is possible to reduce the amount of the refinement processing and, thus, increase the ME speed. As described above, the movement vector is determined for every value of the index refIdx of each list as a vector associated with a smallest energy found out among energies computed for all values of the index BlkIdx which are associated with the index refIdx.

In addition, since an index refIdx and a movement vector are to be found for a band with a size of 4×1 MB, in an access to a memory area in a process to search for a movement vector, the memory used for processing an MB preceding a processed MB is reused so that, by making an access to only a newly required area in the same memory, the number of accesses to the memory can be reduced as shown in a diagram of FIG. 13.

In a state like one shown in a diagram of FIG. 14, however, the method described above undesirably causes the subjective image quality and the compression efficiency to deteriorate.

In principle, this is because the search unit is 4×4 MB to the bitter end so that, if an object is spread over band 1 having a size of 4×1 MB to band 3 with the same size as shown in the diagram of FIG. 14, since the layer search operation is carried out to search for an optimum point providing a minimum energy in the 4×4 MB, the operation turns out to be an operation to follow the movement of an object as shown in the diagram of FIG. 9 even if, for example, point (0, 0) is rather a point giving a minimum energy provided that the search operation is limited to band 0.

By the way, since the process to determine a reference frame is carried out on a band having a size of 4×1 MB, the process results in a movement vector different from the true layer movement vector in the case of band 0.

As a result, the process undesirably causes the image quality and the compression efficiency to deteriorate.

In order to solve these problems raised in the past as described above, inventors of the present invention have innovated an image-information coding apparatus for generating image compressed information by adoption of an image coding system such as the AVC encoding system. The image-information coding apparatus is capable of increasing the speed of a process to search for a movement vector and reducing the number of accesses to a memory without causing the image quality and the compression efficiency to deteriorate.

The image-information coding apparatus innovated by the inventors offers concrete merits which become clearer from the following explanation of preferred embodiments of the present invention.

In order to solve the problems described above, there is provided an image-information coding apparatus employing an A/D conversion section, an image rearrangement buffer, an adder, an orthogonal transformation section, a quantization section, a lossless encoding section, an accumulation buffer, an inverse quantization section, an inverse orthogonal transformation section, a de-block filter, a frame memory for a full resolution, a pixel-skipping section, a frame memory for a 1/N²-resolution, a movement-prediction/compensation section for a 1/N²-resolution, an intra-prediction section, a movement-prediction/compensation section for a full resolution, a rate control section and a reference frame determination section. In a layer search process carried out by the image-information coding apparatus, a search result of point (0, 0) is saved without regard to a minimum energy in the search unit of 4×4 MB. Then, a layer movement vector and a reference frame on a contracted image are determined on the basis of data representing the saved search result of point (0, 0) and data representing an optimum point providing a minimum energy found as a result of the layer search process in order to reduce the amount of the movement-prediction/compensation processing (and, thus, raise the processing speed). In addition, the image-information coding apparatus also includes a section configured to efficiently make accesses to a memory and is also capable of improving the picture quality as well as the compression efficiency as well.

That is to say, in order to solve the problems described above, in accordance with an embodiment of the present invention, there is provided a movement-prediction/compensation method for carrying out processing based on search layers to search for a movement vector by selecting one or more reference frame images for each of movement-compensated blocks obtained as a result of dividing a processed frame image existing among successive frame images. The movement-prediction/compensation method has:

a layer creation step of generating a contracted image at a contraction ratio determined in advance on a low-level search layer by carrying out a pixel skipping process on pixels of the movement-compensated block with a largest pixel size deserving a position on the uppermost-level search layer among pixel sizes of the movement-compensated blocks;

a first movement-prediction/compensation step of searching for a movement vector by making use of the contracted image generated at the layer creation step;

a reference frame image determination step of determining a contracted reference image on the contracted image, the contracted reference image being used at the first movement-prediction/compensation step; and

a second movement-prediction/compensation step of carrying out a movement prediction process for a prior-contraction image by searching for a movement vector through use of a predetermined range specified by the movement vector found at the first movement-prediction/compensation step.

On the assumption that the unit of the layer search processing consists of M×N macro-blocks, at the first movement-prediction/compensation step, every layer search processing unit consisting of M×N macro-blocks is divided into sub-units each consisting of M′×N′ macro-blocks where M′ is in the range between 1 and M whereas N′ is in the range between 1 and N;

an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit; and

the result of the block matching process for search point (0, 0) is also saved.

In addition, at the reference frame image determination step of the movement-prediction/compensation method provided by the embodiment of the present invention, typically, an energy-magnitude comparison process is carried out on a layer search optimum point and each arbitrary point for every sub-unit consisting of M′×N′ blocks in order to change a movement vector.

On top of that, at the reference frame image determination step of the movement-prediction/compensation method provided by the embodiment of the present invention, typically, for every sub-unit consisting of M′×N′ blocks on each reference frame image, an energy-magnitude comparison process is carried out in order to find a reference frame image and a movement vector.

In addition, at the reference frame image determination step of the movement-prediction/compensation method provided by the embodiment of the present invention, typically, if an evaluation figure value for any individual one of the dividing movement-compensated blocks is equal to an evaluation figure value for each corresponding reference frame image, a reference frame image indicated by the smallest index refIdx is selected for the individual movement-compensated block.

On top of that, on the assumption that the unit of the layer search processing consists of M×N macro-blocks, at the first movement-prediction/compensation step of the movement-prediction/compensation method provided by the embodiment of the present invention, typically:

every layer search processing unit consisting of M×N macro-blocks is divided into sub-units each consisting of M′×N′ macro-blocks where M′ is in the range between 1 and M whereas N′ is in the range between 1 and N; and

an SATD (Sum of Absolute orthogonally Transformed Differences) is obtained and saved for each sub-unit, which consists of M′×N′ macro-blocks, of a layer search processing unit consisting of M×N macro-blocks as a result of a block matching process carried out on the layer search processing unit.

In addition, on the assumption that the unit of the layer search processing consists of M×N macro-blocks, at the first movement-prediction/compensation step of the movement-prediction/compensation method provided by the embodiment of the present invention, typically:

every layer search processing unit consisting of M×N macro-blocks is divided into sub-units each consisting of M′ X N′ macro-blocks where M′ is in the range between 1 and M whereas N′ is in the range between 1 and N; and

an SSD (Sum of Squared Differences) is obtained and saved for each sub-unit, which consists of M′×N′ macro-blocks, of a layer search processing unit consisting of M×N macro-blocks as a result of a block matching process carried out on the layer search processing unit.

On top of that, at the reference frame image determination step of the movement-prediction/compensation method provided by the embodiment of the present invention, typically, a sum of arbitrarily weighted values of the index refIdx indicating a reference frame image is also used as an evaluation figure value besides an evaluation figure value computed from results of the block matching process.

In addition, on the assumption that the unit of the layer search processing consists of M×N macro-blocks, at the first movement-prediction/compensation step of the movement-prediction/compensation method provided by the embodiment of the present invention, typically:

every layer search processing unit consisting of M×N macro-blocks is divided into sub-units each consisting of M′×N′ macro-blocks where M′ is in the range between 1 and M whereas N′ is in the range between 1 and N;

an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit; and

a search process result for any set point is also saved along with a search process result for search point (0, 0).

On top of that, in order to solve the problems described above, in accordance with another embodiment of the present invention, there is provided a movement-prediction/compensation apparatus for carrying out processing based on layer search layers to search for a movement vector by selecting a reference frame image including a reference block associated with one of movement-compensated blocks obtained as a result of dividing a processed frame image existing among successive frame images or by selecting two or more reference frame images each including such a reference block among a plurality of reference frame images for each of the movement-compensated blocks. The movement-prediction/compensation apparatus includes the movement-prediction/compensation section having:

a layer creation section configured to generate a contracted image at a contraction ratio determined in advance on a low-level search layer by carrying out a pixel skipping process on pixels of the movement-compensated block with a largest pixel size deserving a position on the uppermost-level search layer among pixel sizes of the movement-compensated blocks;

a first movement-prediction/compensation section configured to search for a movement vector by making use of the contracted image generated by the hierarchy creation section;

a reference frame image determination section configured to determine a contracted reference image on the contracted image, the contracted reference image being used at the first movement-prediction/compensation section; and

a second movement-prediction/compensation section configured to carry out a movement prediction process for a prior-contraction image by searching for a movement vector through use of a predetermined range specified by the movement vector found by the first movement-prediction/compensation section.

On the assumption that the unit of the layer search processing consists of M×N macro-blocks, in the first movement-prediction/compensation section, every layer search processing unit consisting of M×N macro-blocks is divided into sub-units each consisting of M′×N′ macro-blocks where M′ is in the range between 1 and M whereas N′ is in the range between 1 and N;

an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit; and

the result of the block matching process for search point (0, 0) is also saved.

In addition, in the reference frame image determination section employed in the movement-prediction/compensation apparatus provided by the embodiment of the present invention, typically, an energy-magnitude comparison process is carried out on a layer search optimum point and each arbitrary point for every sub-unit consisting of M′×N′ blocks in order to change a movement vector.

On top of that, in the reference frame image determination section employed in the movement-prediction/compensation apparatus provided by the embodiment of the present invention, typically, for every sub-unit consisting of M′×N′ blocks on each reference frame image, an energy-magnitude comparison process is carried out on the reference frame image in order to find a reference frame image and a movement vector.

In addition, in the reference frame image determination section employed in the movement-prediction/compensation apparatus provided by the embodiment of the present invention, typically, if an evaluation figure value for any individual one of the divided movement-compensated blocks is equal to an evaluation figure value for a corresponding reference block on each of the reference frame images, a reference frame image indicated by the smallest index refIdx is selected for the individual movement-compensated block.

On top of that, on the assumption that the unit of the layer search processing consists of M×N macro-blocks, in the first movement-prediction/compensation section employed in the movement-prediction/compensation apparatus provided by the embodiment of the present invention, typically:

every layer search processing unit consisting of M×N macro-blocks is divided into sub-units each consisting of M′×N′ macro-blocks where M′ is in the range between 1 and M whereas N′ is in the range between 1 and N; and

an SATD (Sum of Absolute orthogonally Transformed Differences) is obtained and saved for each sub-unit, which consists of M′×N′ macro-blocks, of a layer search processing unit consisting of M×N macro-blocks as a result of a block matching process carried out on the layer search processing unit.

In addition, on the assumption that the unit of the layer search processing consists of M×N macro-blocks, in the first movement-prediction/compensation section employed in the movement-prediction/compensation apparatus provided by the embodiment of the present invention, typically:

every layer search processing unit consisting of M×N macro-blocks is divided into sub-units each consisting of M′×N′ macro-blocks where M′ is in the range between 1 and M whereas N′ is in the range between 1 and N; and

an SSD (Sum of Squared Differences) is obtained and saved for each sub-unit, which consists of M′×N′ macro-blocks, of a layer search processing unit consisting of M×N macro-blocks as a result of a block matching process carried out on the layer search processing unit.

On top of that, in the reference frame image determination section employed in the movement-prediction/compensation apparatus provided by the embodiment of the present invention, typically, a sum of arbitrarily weighted values of the index refIdx indicating a reference frame image is also used as an evaluation figure value besides an evaluation figure value computed from results of the block matching process.

In addition, on the assumption that the unit of the layer search processing consists of M×N macro-blocks, in the first movement-prediction/compensation section employed in the movement-prediction/compensation apparatus provided by the embodiment of the present invention, typically:

every layer search processing unit consisting of M×N macro-blocks is divided into sub-units each consisting of M′×N′ macro-blocks where M′ is in the range between 1 and M whereas N′ is in the range between 1 and N;

an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit; and

a search process result for any set point is also saved along with a search process result for search point (0, 0).

In an image-information coding apparatus for generating image compressed information by adoption of an image coding method such as the AVC encoding system, at a search time, besides a search result at a point located on a contracted image as a point providing a smallest energy, a search result at point (0, 0) or any arbitrary point is also saved separately for any arbitrary sub-unit in order to solve a search problem described earlier as a search problem on the contracted image. In addition, by determining an index refIdx indicating a reference frame for every arbitrary sub-unit on the contracted image, the amount of the refinement processing can be reduced so that it is possible to search for a movement vector in a shorter period of time and reduce the number of accesses to a memory.

### BRIEF DESCRIPTION OF THE DRAWINGS

FIG. 1 is a block diagram showing the configuration of an image-information coding apparatus for implementing processing to compress image information in accordance with a movement compensation technique and an orthogonal transformation technique such as the discrete cosine transformation or the Karhunen-Loeve transformation;

FIG. 2 is a block diagram showing the configuration of an image-information decoding apparatus for implementing processing to decompress image compressed information in accordance with a movement compensation technique and an orthogonal transformation technique such as the discrete cosine transformation or the Karhunen-Loeve transformation;

FIG. 3 is a diagram showing a multiple reference frame concept prescribed in an AVC encoding system;

FIG. 4 is a diagram showing the concept of movement compensation processing based on a variable block size as prescribed in the AVC encoding system;

FIG. 5 is an explanatory diagram to be referred to in description of movement compensation processing carried out at a ¼-pixel precision as prescribed in the AVC encoding system;

FIG. 6 is a block diagram showing the configuration of an image-information coding apparatus proposed earlier in the diagram of FIG. 1;

FIG. 7 is an explanatory diagram to be referred to in description of the principle of an operation carried out by a pixel skipping section employed in the image-information coding apparatus shown in the diagram of FIG. 6;

FIG. 8 is an explanatory diagram to be referred to in description of processing carried out by the image-information coding apparatus shown in the diagram of FIG. 6 as an apparatus with a 1/N² resolution to compute a predicted energy by making use of pixel values specified on a grid;

FIG. 9 is a block diagram showing the configuration of another image-information coding apparatus;

FIG. 10 is a diagram showing a relation between a contracted image and a reference image in the image-information coding apparatus shown in the diagram of FIG. 9;

FIG. 11 is a diagram showing typical division of a multi-block unit into a plurality of multi-block bands in the image-information coding apparatus shown in the diagram of FIG. 9;

FIG. 12 shows a flowchart representing the procedure of image processing carried out by the image-information coding apparatus shown in the diagram of FIG. 9;

FIG. 13 is a diagram showing how to reduce the number of accesses to a memory in the image-information coding apparatus shown in the diagram of FIG. 9;

FIG. 14 is an explanatory diagram to be referred to in description of a problem to be solved by the present invention;

FIG. 15 is a block diagram showing the configuration of an image-information coding apparatus according to an embodiment of the present invention;

FIG. 16 shows a flowchart representing the procedure of image processing carried out by the image-information coding apparatus according to the embodiment of the present invention;

FIG. 17 is a block diagram showing the configuration of an image-information coding apparatus according to another embodiment of the present invention; and

FIG. 18 shows a flowchart representing the procedure of image processing carried out by the image-information coding apparatus shown in the diagram of FIG. 17.

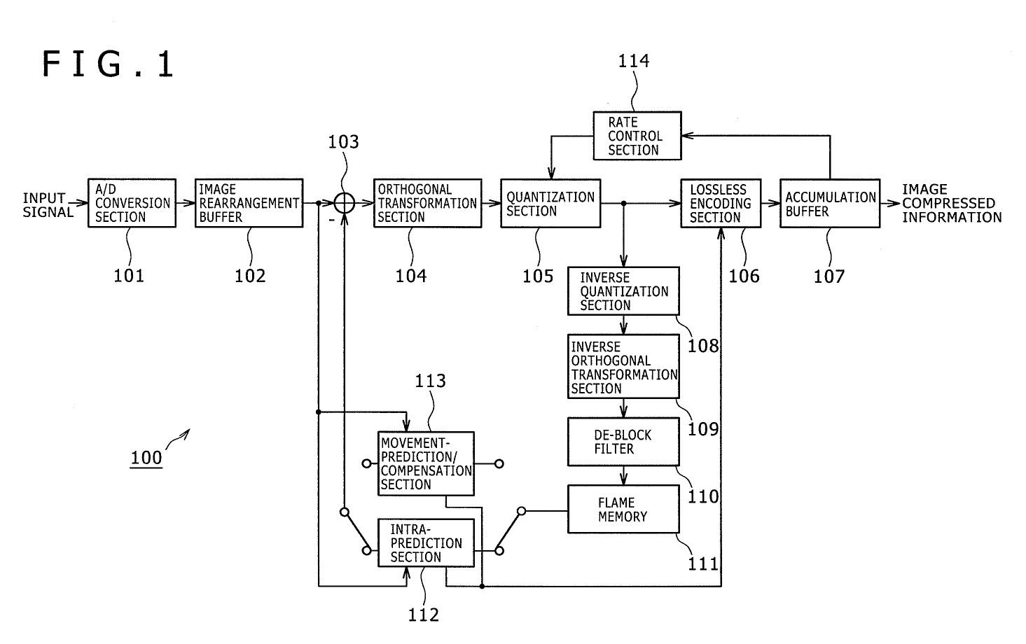

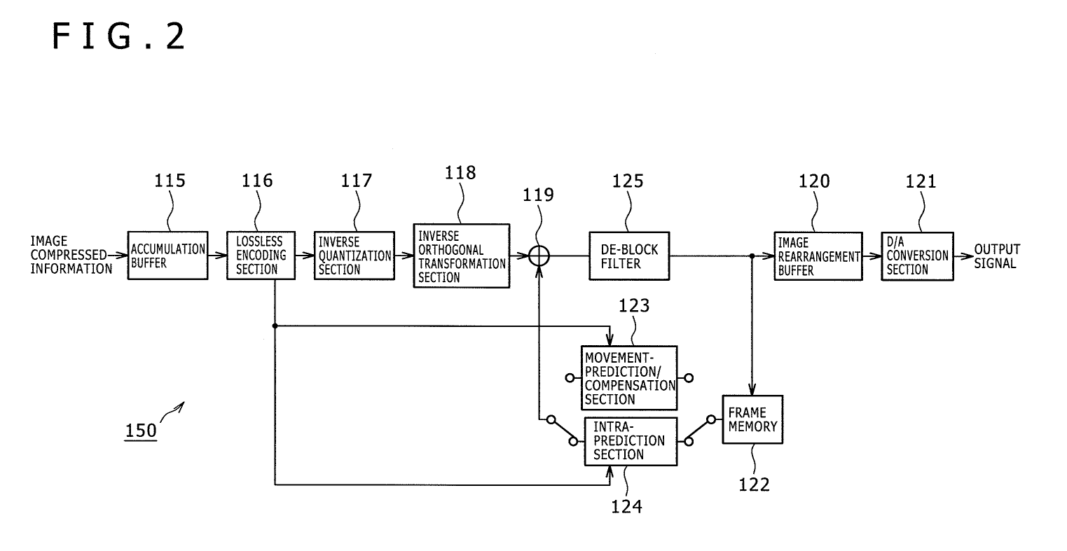

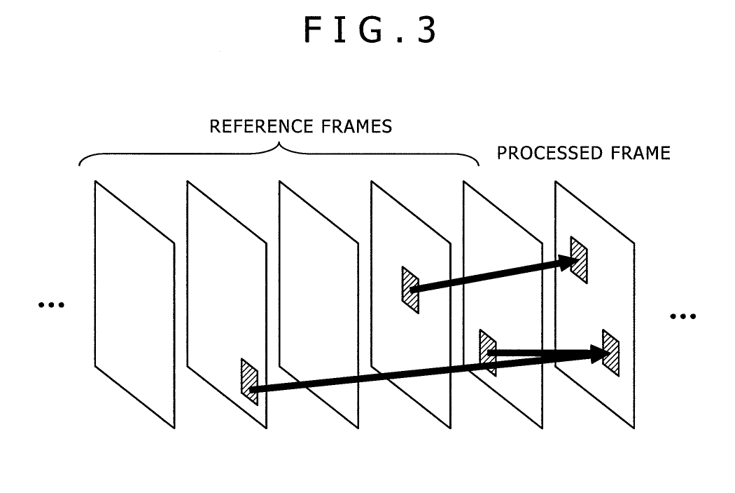

### DETAILED DESCRIPTION OF THE PREFERRED EMBODIMENTS

Embodiments of the present invention are explained in detail by referring to diagrams as follows. It is to be noted, however, that the scope of the present invention is not limited to the embodiments. In other words, it is needless to say that arbitrary changes can be made to each of the embodiments as long as the changes are within a range not deviating from essentials of the present invention.

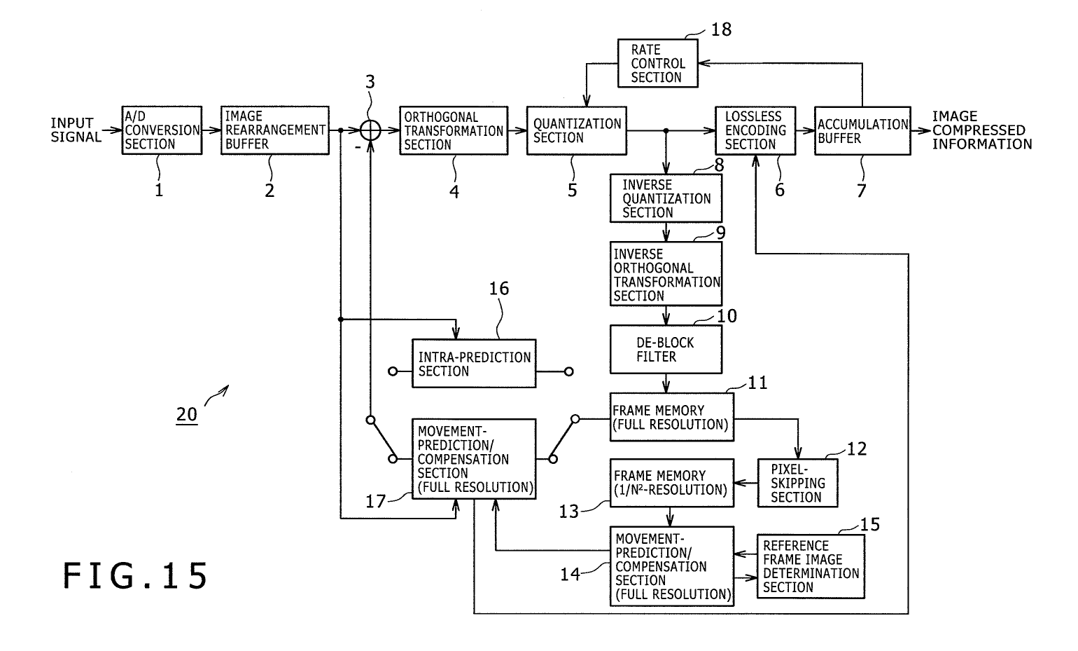

For example, the present invention can be applied to an image-information coding apparatus 20 with a configuration like one shown in a block diagram of FIG. 15.

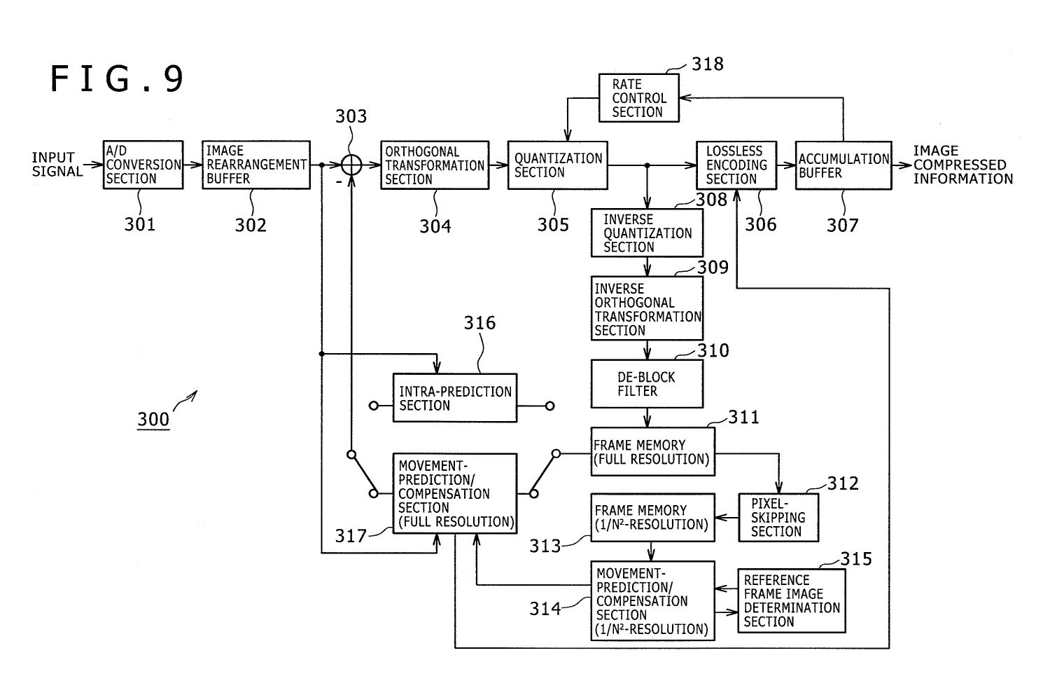

The image-information coding apparatus 20 is obtained by improving the image-information coding apparatus 300 shown in the block diagram of FIG. 9 disclosed by inventors of the present invention in Japanese Patent Laid-open No. 2004-191937. As shown in the block diagram of FIG. 15, the image-information coding apparatus 20 includes: an A/D conversion section 1 supplied with an input image signal; an image rearrangement buffer 2 for storing the digital image data output by the A/D conversion section 1; an adder 3 supplied with image data read out from the image rearrangement buffer 2; an intra-prediction section 16; a full-resolution movement-prediction/compensation section 17; an orthogonal transformation section 4 supplied with outputs by the adder 3, intra-prediction section 16 and full-resolution movement-prediction/compensation section 17; a quantization section 5 supplied with an output by the orthogonal transformation section 4; a lossless encoding section 6 and an inverse quantization section 8 each supplied with an output by the quantization section 5; an accumulation buffer 7 supplied with an output by the lossless encoding section 6; a rate control section 18 supplied with an output by the accumulation buffer 7; an inverse orthogonal transformation section 9 supplied with an output by the inverse quantization section 8; a de-block filter 10 supplied with an output by the inverse orthogonal transformation section 9; a full-resolution frame memory 11 supplied with an output by the de-block filter 10, a pixel skipping section 12 supplied with an output by the full-resolution frame memory 11, a 1/N²-resolution frame memory 13 supplied with an output by the pixel skipping section 12; a full-resolution movement-prediction/compensation section 14 supplied with an output by the 1/N²-resolution frame memory 13; and a reference-frame determination section 15 connected to the full-resolution movement-prediction/compensation section 14.

Differences between the image-information coding apparatus 200 shown in the block diagram of FIG. 9 and the image-information coding apparatus 20 shown in the block diagram of FIG. 15 are the principles of operations carried out by the 1/N²-resolution movement-prediction/compensation section 14 and the reference-frame determination section 15. Thus, the principles of the operations carried out by the 1/N²-resolution movement-prediction/compensation section 14 and the reference-frame determination section 15 are explained as follows.

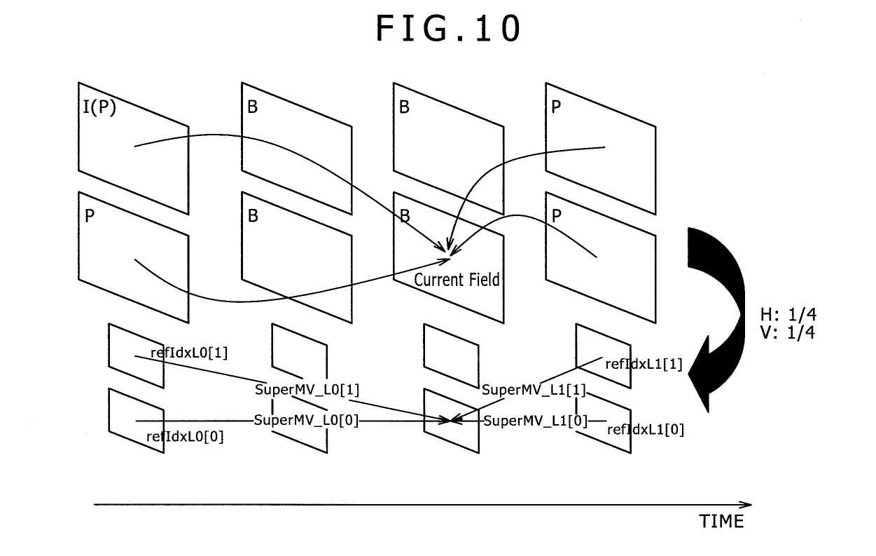

In the same way as the image-information coding apparatus 200 described earlier, the principles of the operations are exemplified by making use of the concrete example shown in the diagram of FIG. 10. In this process, as described before, the processed field is the bottom field of a B picture whereas the reference fields are two fields on the forward (List0) side and two fields on the backward (List1) side. The contraction ratio N of the 1/N²-resolution frame memory 13 is 4.

First of all, the principle of the operation carried out by the 1/N²-resolution movement-prediction/compensation section 14 is explained as follows.

In the case of the image-information coding apparatus 200, the 1/N²-resolution movement-prediction/compensation section 314 merely searches a search unit for a point providing a smallest energy in the search unit and saves the smallest energy at this point. In the case of the image-information coding apparatus 20, on the other hand, not only does the 1/N²-resolution movement-prediction/compensation section 14 search a search unit for a point providing a smallest energy in the search unit and save the smallest energy at this point, but the 1/N²-resolution movement-prediction/compensation section 14 also additionally saves an energy at point (0, 0) for each band used as a sub-unit, which is set for a determined reference frame as a sub-unit consisting of 4×1 MB.

Let the result of the movement-vector search process for a point providing a smallest energy be defined as SAD [0] [List][refIdx][BlkIdx] and the result of the movement-vector search process for point (0, 0) be defined as SAD [1] [List][refIdx][BlkIdx].

A point pointed to by a movement vector associated with an energy, which is to be additionally saved, does not to be point (0, 0) but can be any arbitrary point.

Next, the principle of the operation carried out by the reference-frame determination section 15 is explained as follows.

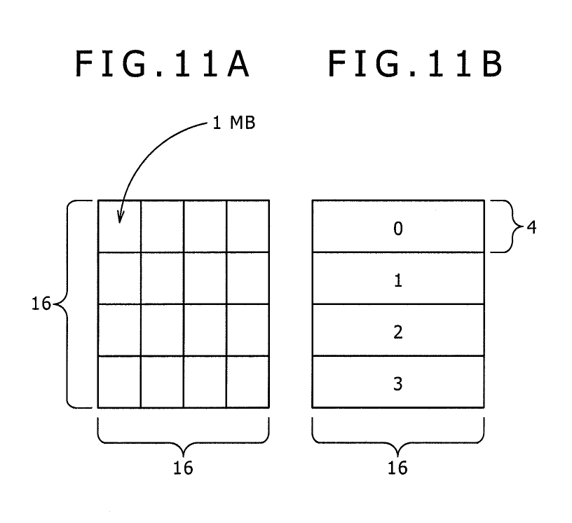

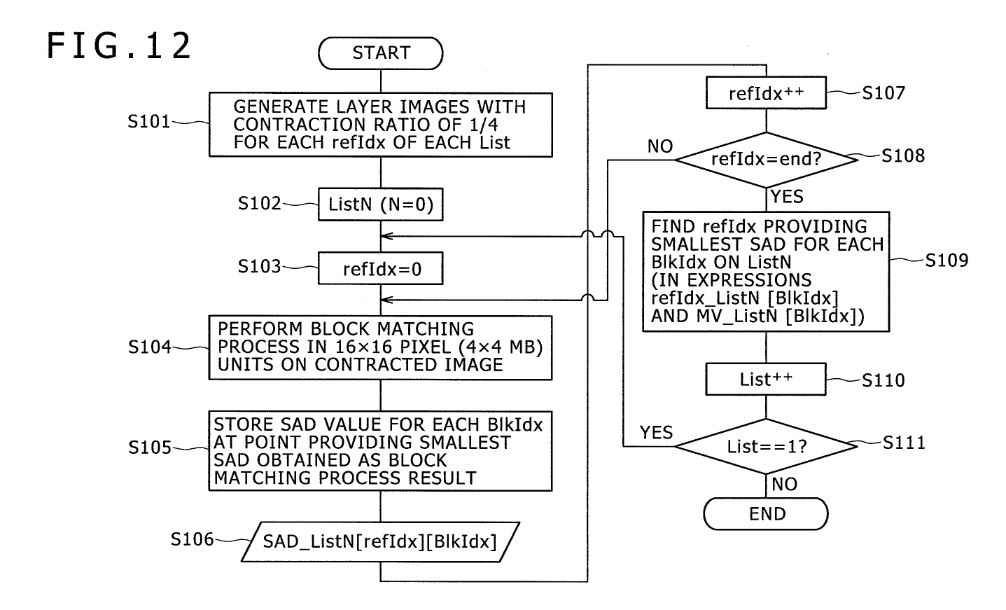

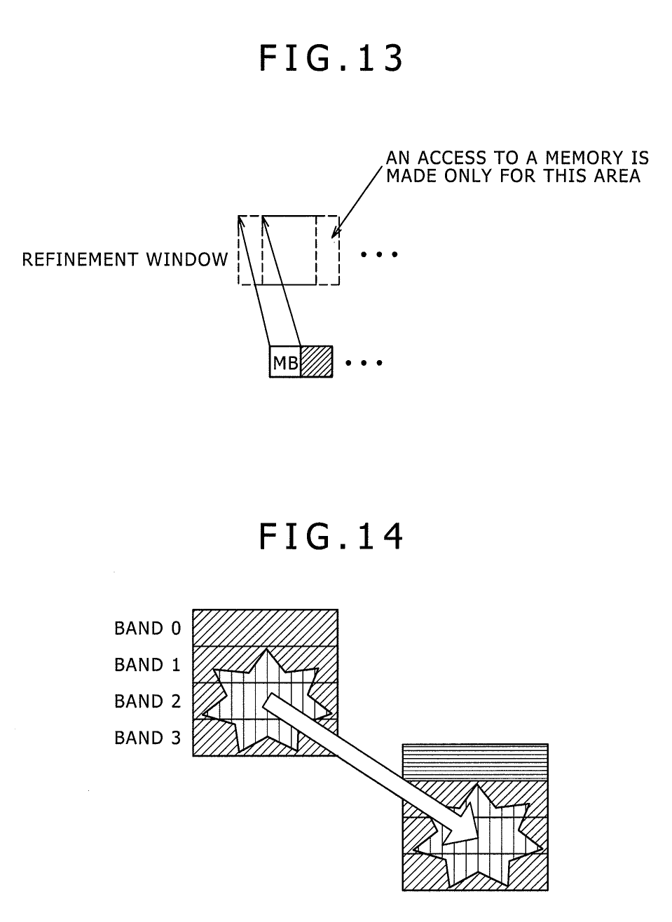

For every band consisting of 4×1 MB as shown in the diagram of FIG. 11B, the energy SAD [0] is compared with the energy SAD [1] in order to determine a pair composed of a movement vector and an energy as a pair for a band indicated by the index BlkIdx as a band in a reference frame indicated by the index refIdx.

The energy of a pair determined as described above is defined as SAD [List][refIdx][BlkIdx].

The movement vector of the pair determined as described above is defined as Mv [List][refIdx][BlkIdx].

As described above, the SAD is used as an evaluation figure in the comparison. However, the SATD or the SSD can also be used as an evaluation figure in place of the SAD.

In addition, besides the SAD, the SATD and the SSD which are found from residual energies, as an evaluation figure value, it is also possible to use the sum of the SAD, the SATD or the SSD and a movement vector Mv multiplied by an arbitrary weight λ₁.

In this image-information coding apparatus 20, first of all, the A/D conversion section 1 converts an analog input image signal into a digital signal. Then, on the basis of a GOP (Group of Pictures) structure of image compressed information to be output by the image-information coding apparatus 20, in the image rearrangement buffer 2, frames of the digital signal output by the A/D conversion section 1 are rearranged.

In the case of an image to be subjected to an intra-coding process, the adder 3 provides the orthogonal transformation section 4 with a difference obtained as a result of subtracting information output by the intra-prediction section 16 as information on differences between pixel values from the input image information read out from the image rearrangement buffer 2. The orthogonal transformation section 4 then carries out orthogonal transformation processing on the difference. The orthogonal transformation processing is typically a discrete cosine transformation process or a Karhunen-Loeve transformation process.

Then, the quantization section 5 carries out a quantization process on transformation coefficients generated by the orthogonal transformation section 4 as a result of the orthogonal transformation processing. Subsequently, the lossless encoding section 6 carries out lossless encoding processing on quantized transformation coefficients generated by the quantization section 5 as a result of the quantization process. The lossless encoding processing includes a variable-length encoding process and an arithmetic encoding process. Data output by the lossless encoding section 6 is then stored in the accumulation buffer 7 to be eventually output as image compressed information. The quantization process performed by the quantization section 5 is controlled by the rate control section 18 on the basis of a signal output by the accumulation buffer 7 to the rate control section 18. The quantized transformation coefficients generated by the quantization section 5 are also supplied to the inverse quantization section 8 at the same time. Then, the inverse quantization section 8 carries out an inverse quantization process on the quantized transformation coefficients output by the quantization section 5. Subsequently, the inverse orthogonal transformation section 9 carries out an inverse orthogonal transformation process on data output by the inverse quantization section 8 as a result of the inverse quantization process in order to generate decoded image information which is then supplied to the de-block filter 10. The de-block filter 10 carries out a filtering process to remove block distortions from the decoded image information and then stores the result of the filtering process in the full-resolution frame memory 11. The intra-prediction section 16 reads out the image information from the full-resolution frame memory 11 and carries out an intra-prediction process on the image information. The intra-prediction section 16 then supplies the aforementioned information on differences between pixel values as a result obtained from the intra-prediction process to the adder 3. The intra-prediction section 16 also provides the lossless encoding section 6 with information on an intra-prediction mode applied to the blocks/macro-blocks of the image information subjected to the intra-prediction process. The lossless encoding section 6 then carries out an encoding process on the information on an intra-prediction mode by handling the information as a portion of the header of the image compressed information.

As for an image to be subjected to an inter-encoding process, first, the image information is supplied to the movement-prediction/compensation section 17. At the same time, reference image information is fetched from the frame memory 11 and subjected to a movement-prediction/compensation process, whereby reference image information is generated. The reference image information is sent to the adder 3, here converted to a difference signal representing difference with the input image information. At the same time, the movement-prediction/compensation section 17 also supplies movement vector information to the lossless encoding section 6. Subsequently, the lossless encoding section 6 carries out the lossless encoding processing such as a variable-length coding process and an arithmetic coding process in order to generate information to be inserted into the header of the image compressed information. The remaining processes are the same as those described previously as the processes carried out on an image to be subjected to the intra-coding processing.

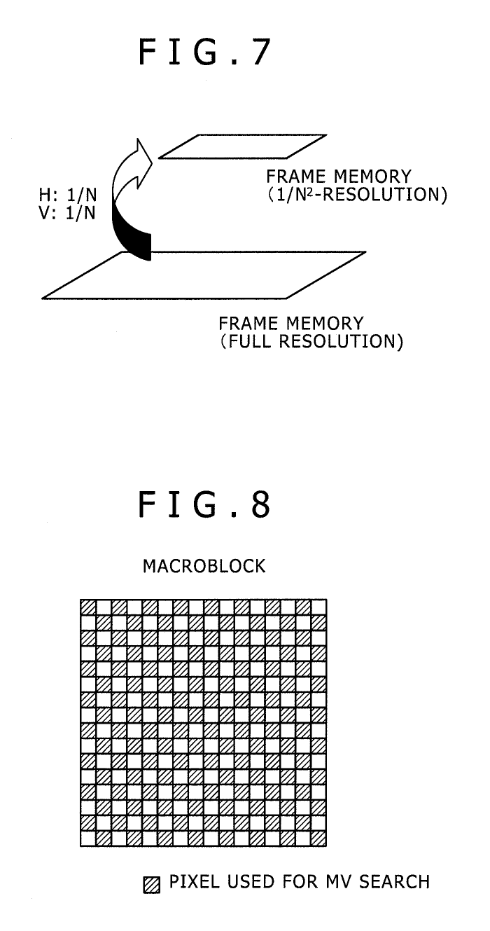

The principle of the operation carried out by the pixel skipping section 12 employed in the image-information coding apparatus 20 is described by referring to the diagram of FIG. 7. The pixel skipping section 12 reads out image information from the full-resolution frame memory 11 and carries out a 1/N pixel skipping process in both the horizontal and vertical directions on the image information in order to generate pixel values which are then stored in the 1/N²-resolution frame memory 13.

The 1/N²-resolution movement-prediction/compensation section 14 carries out a block matching process on 8×8 blocks or 16×16 blocks by making use of pixel values stored in the 1/N²-resolution frame memory 13 as pixel values of the blocks in order to search for optimum movement vector information for the matching blocks. In the block matching process, a predicted energy is computed not by making use of all pixel values. Instead, the predicted energy is computed by making use of pixel values specified on a grid shown in the diagram of FIG. 8.

In a process to carry out a field encoding process on the picture, a pixel skipping process shown in the diagram of FIG. 7 is carried out by dividing the picture into first and second fields.

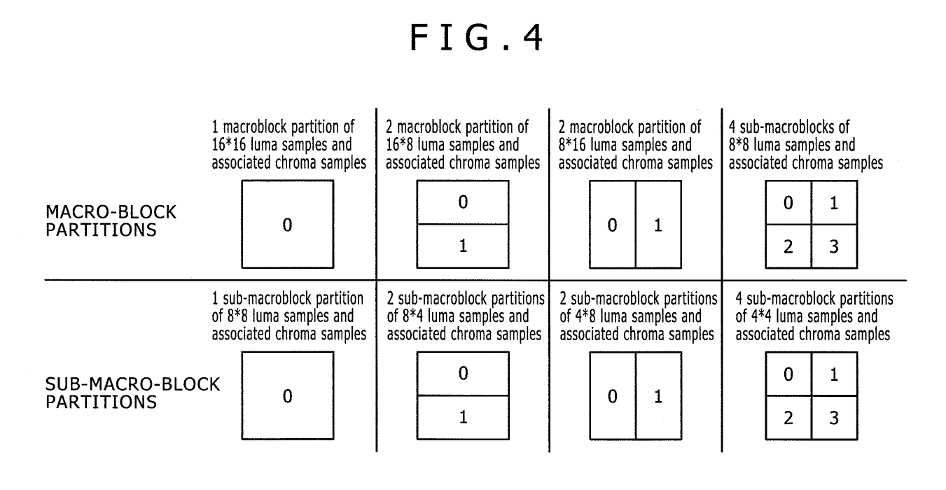

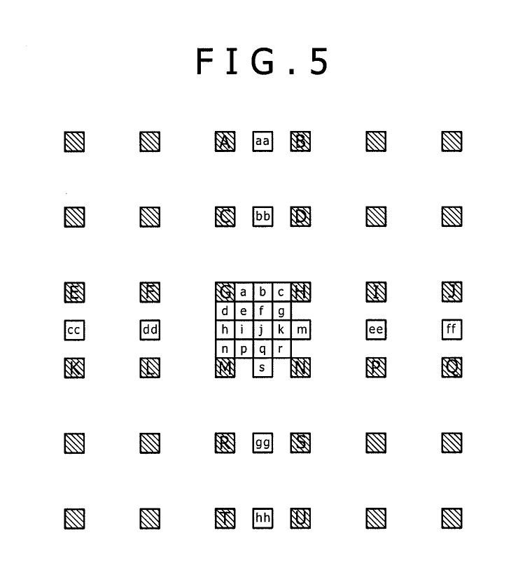

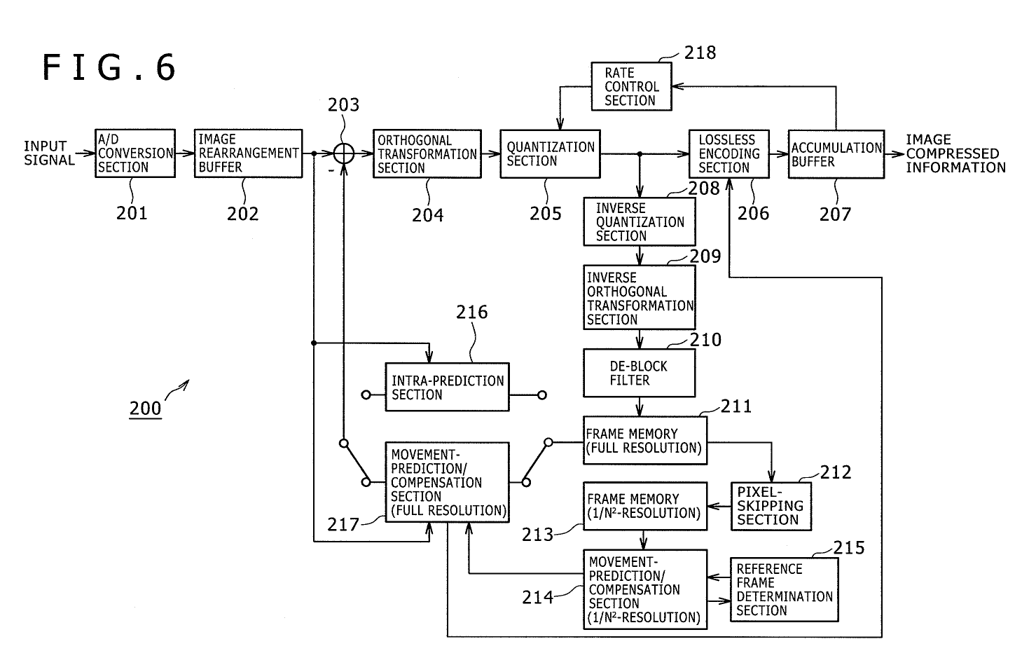

As above, the movement vector information found in the search process making use of a contracted image as described above is supplied to the full-resolution movement-prediction/compensation section 17. For example, for N=2, in the case of 8×8 blocks used as the unit of the search operation, the 1/N²-resolution movement-prediction/compensation section 14 (¼-resolution) sets 16×16 blocks for 1 macro block. In the case of 16×16 blocks used as the unit of the search operation, on the other hand, the 1/N²-resolution movement-prediction/compensation section 14 sets 16×16 blocks for four macro blocks. However, the full-resolution movement-prediction/compensation section 17 searches a very small range centered at these 16×16 movement vectors for all pieces of movement vector information which are defined as shown in the diagram of FIG. 4. By carrying out a movement prediction process for a very small search range on the basis of movement vector information found on the contracted image in this way, it is possible to substantially reduce the amount of processing carried out in order to search for movement vector information while minimizing the deterioration in image quality.

A reference frame or reference frames for each movement-compensated block are determined as follows.

The 1/N²-resolution movement-prediction/compensation section 14 detects a movement vector for each candidate reference frame. The full-resolution movement-prediction/compensation section 17 carries out a refinement process on a movement vector detected for each candidate reference frame. Then, a reference frame that minimizes a residual energy or some kind of cost function is selected as the reference frame for the movement-compensated block.

By the way, in the AVC encoding system, the multiple reference frame method, the variable movement-prediction/compensation block size method and the ¼-pixel precision movement compensation method are allowed. Thus, if the number of candidate reference frames increases, a refinement process carried out by the full-resolution movement-prediction/compensation section 17 undesirably becomes heavier.

In addition, if an image-information coding apparatus implemented by H/W (hardware) is taken into consideration, a movement search process is carried out for all block sizes in a macro-block for every reference frame. Thus, since the number of accesses to a memory increases, it becomes necessary to raise the memory band in some cases.

FIG. 10 is a diagram referred to in explanation of a typical concrete field encoding process. In this typical field encoding process, the processed field is the bottom field of a B picture whereas the reference fields are two fields on the forward (List0) side and two fields on the backward (List1) side. The contraction ratio N of the 1/N²-resolution frame memory 13 is 4.

By carrying out a block matching process for every reference field, the 1/N²-resolution movement-prediction/compensation section 14 is capable of detecting an optimum movement vector. The full-resolution movement-prediction/compensation section 17 then carries out a refinement process for all block sizes with the movement vector taken as a center. If a reference field is determined for each list, however, the refinement process carried out by the full-resolution movement-prediction/compensation section 17 becomes undesirably heavy. In order to solve this problem, the reference-frame determination section 15 employed in the image-information coding apparatus 20 determines a reference field as shown in the diagrams of FIGS. 10 and 11.

At a contraction ratio of ¼ (H=¼ and V=¼) shown in the diagram of FIG. 10, the 1/N²-resolution movement-prediction/compensation section 14 (where N=4) takes a block-matching unit consisting of 16×16 blocks as shown in a diagram of FIG. 11A. In this case, the full-resolution movement-prediction/compensation section 17 sets a single movement vector pointing to 4×4 (=16) macro-blocks like the ones shown in FIG. 11A.

Then, the image-information coding apparatus 20 divides the block-matching unit consisting of 16×16 blocks into bands each consisting of 16×4 blocks as shown in a diagram of FIG. 11B. In the block matching process carried out on the 16×16 blocks, the 1/N²-resolution movement-prediction/compensation section 14 (where N=4 or 1/N= 1/16) keeps an energy (SAD) for each of bands each consisting of 16×4 blocks. A band corresponds to a field described earlier.

That is to say, let us set the values of 4 indexes (BlkIdx) each indicating one of the 4 bands at 0 to 3 with the index 0 assigned to the top band, the index 1 assigned to the band next to the top band and so on as shown in the diagram of FIG. 11B. In this case, for each of the reference fields, it is possible to obtain an energy SAD_ListX[refIdx][BlkIdx] according to Eq. (8) given earlier.

In the above equation, notation SAD_ListX[refIdx][BlkIdx] denotes an energy SAD which is stored for each value of the index BlkIdx as an energy for an optimum movement vector found in 16×16 block matching process for every value of the index refIdx of each list.

In addition, the 16×16 block matching processes result in optimum movement vectors Mv_ListX[refIdx] (that is, optimum movement vectors MV_List0 [0], MV_List0 [1], MV_List1 [0], and MV_List1 [1]).

In this process, the reference-frame determination section 15 compares residual energies, which are each associated with an index BlkIdx indicating a field on a frame on a list, with each other in accordance with Eq. (9) given earlier in order to determine a smallest energy reference field as a reference field having 16×4 blocks as shown in the diagram of FIG. 11B.

In addition, a movement vector MV_ListN[refIdx] is also determined for a smallest energy found out for every value of the index refIdx.

If energies each computed for a reference field are equal to each other, a reference field indicated by the smallest index refIdx is selected.

By carrying out the processing described above, it is possible to obtain a reference field (refIdx_ListN[BlkIdx]) and a movement vector (Mv_ListN[BlkIdx]) for every value of the index BlkIdx.

In this case, the SAD (Sum of Absolute Differences) obtained as a result of a block matching process carried out on M×N macro-blocks is used as an evaluation figure in the comparison. However, either of the SATD (Sum of Absolute orthogonally Transformed Differences) and the SSD (Sum of Squared Differences) which are obtained as a result of a block matching process carried out on M×N macro-blocks can also be used as an evaluation figure in place of the SAD.

In addition, besides the SAD, the SATD and the SSD which are found from residual energies, as an evaluation figure value, it is also possible to use the sum of the SAD, the SATD or the SSD and the index refIdx multiplied by an arbitrary weight λ₁.

An evaluation figure value named Cost is defined by equation (10) as follows.

### [Equation 10]

Cost=SAD+λ₁×refIdx (10)

On top of that, a product obtained as a result of multiplying the quantity of the movement vector by a weight λ₂ can also be used as an evaluation figure value.

To put it concretely, the evaluation figure value named Cost is redefined by equation (11) including the weight λ₂ as follows.

### [Equation 11]

Cost=SAD+λ₁×refIdx+λ₂×MV (11)

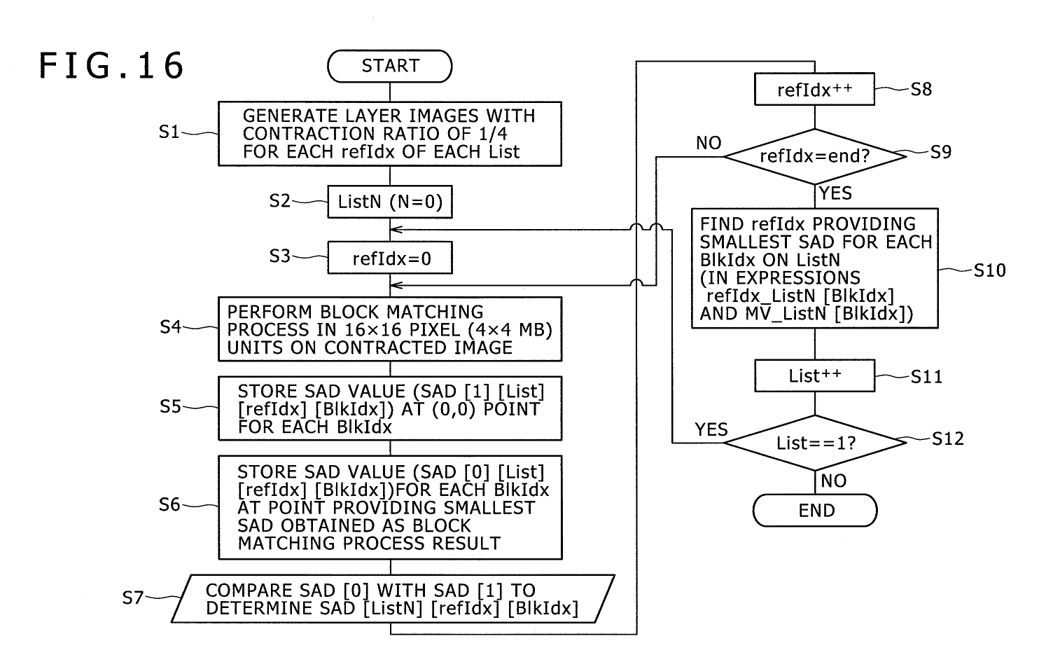

By referring to a flowchart shown in FIG. 16, the following description explains image processing which is carried out by the image-information coding apparatus 20 in accordance with a procedure represented by the flowchart.

The flowchart begins with a step S1 at which the pixel skipping section 12 reads out image information from the full-resolution frame memory 11 and carries out a 1/N pixel skipping process in both the horizontal and vertical directions on the image information in order to generate pixel values which are then stored in the 1/N²-resolution frame memory 13.

Then, at the next step S2, the list number N is set at 0 (List0 is taken as ListN).

Subsequently, at the next step S3, the index refIdx is set at 0 (refIdx=0).

Then, at the next step S4, the 1/N²-resolution movement-prediction/compensation section 14 carries out a block matching process by making use of pixel values stored in the 1/N²-resolution frame memory 13 as pixel values of the blocks in order to search for optimum movement vector information for the matching blocks.

Subsequently, at the next step S5, an SAD value for point (0, 0) is stored for each value of the index BlkIdx.

Then, at the next step S6, an SAD value for a point providing a smallest SAD value obtained as a result of the block matching process is stored for each value of the index BlkIdx.

Subsequently, at the next step S7, the SAD value (SAD [1] [List][refIdx][BlkIdx]) stored in the process carried out at the step S5 for each value of the index BlkIdx as an SAD value for point (0, 0) is compared with the SAD value (SAD [0] [List][refIdx][BlkIdx]) stored in the process carried out at the step S5 for each value of the index BlkIdx as an SAD value for a point providing a smallest SAD value in order to determine a pair consisting of a movement vector and an energy SAD_[List][refIdx][BlkIdx] for the reference image.

Notation SAD_ListN[refIdx][BlkIdx] denotes an energy SAD which is determined and stored in the process carried out at the step S7 for each value of the index BlkIdx as an energy for an optimum movement vector found in 16×16 blocks matching process for every value of the index refIdx of each list (ListN).

Then, at the next step S8, the index refIdx is incremented by 1.

Subsequently, the flow of the processing goes on to a step S9 in order to produce a result of determination as to whether or not the index refIdx has become equal to its maximum value. If the determination result produced in the process carried out at the step S9 is NO indicating that the index refIdx has not become equal to its maximum value, the flow of the processing goes back to the step S4 in order to repeat the processes of the steps S4 to S9.

If the determination result produced in the process carried out at the step S9 is YES indicating that the index refIdx has already become equal to its maximum value, on the other hand, the flow of the processing goes on to a step S10 at which an index refIdx providing a smallest SAD is found for every value of the index BlkIdx of ListN.

Then, at the next step S11, the list number N is incremented by 1 (List (N++)).

Subsequently, the flow of the processing goes on to a step S12 in order to produce a result of determination as to whether or not the list number N is equal to 1 indicating that the list is List1. If the determination result produced in the process carried out at the step S12 is YES indicating that the list number N is equal to 1, the flow of the processing goes back to the step S3 in order to repeat the processes of the steps S3 to S12. If the determination result produced in the process carried out at the step S12 is NO indicating that the list number N is equal to 0 or the list is List0, on the other hand, the processing represented by this flowchart is ended.

By carrying out refinement processing only on the surroundings of an area pointed to by a determined movement vector, it is possible to reduce the amount of the refinement processing and, thus, increase the ME speed. As described above, the movement vector is determined for every value of the index refIdx of each list as a vector associated with a smallest energy found out among energies computed for all values of the index BlkIdx which are associated with the index refIdx.

Then, by carrying out refinement processing only on the surroundings of an area pointed to by a determined movement vector, it is possible to reduce the amount of the refinement processing and, thus, increase the ME speed. As described above, the movement vector is determined for every value of the index refIdx of each list as a vector associated with a smallest energy found out among energies computed for all values of the index BlkIdx which are associated with the index refIdx.

The processing described above is processing carried out in field units. However, the processing can also be carried out in frame units in the same way.

In addition, a band with a size of 4×1 MB is taken as an example in the processing described above. However, every layer search processing unit consisting of M×N macro-blocks on a contracted image can be divided into sub-units each indicated by the index BlkIdx as a sub-unit consisting of M×N′ macro-blocks where N′ is equal to or greater than 1 but, if N′ is greater than 1, N′ is equal to or smaller than N or a sub-unit consisting of M′×N macro-blocks where M′ is equal to or greater than 1 but, if M′ is greater than 1, M′ is equal to or smaller than M.

As described above, in the image-information coding apparatus 20 for generating image compressed information by adoption of an image coding method such as the AVC encoding system, at a search time, besides a search result at a point located on a contracted image as a point providing a smallest energy, a search result at point (0, 0) or any arbitrary point is also saved separately for any arbitrary sub-unit in order to solve a search problem described earlier as a search problem on the contracted image. In addition, by determining an index refIdx indicating a reference frame only for any arbitrary sub-unit on the contracted image, the amount of the refinement processing can be reduced so that it is possible to search for a movement vector in a shorter period of time and reduce the number of accesses to a memory.

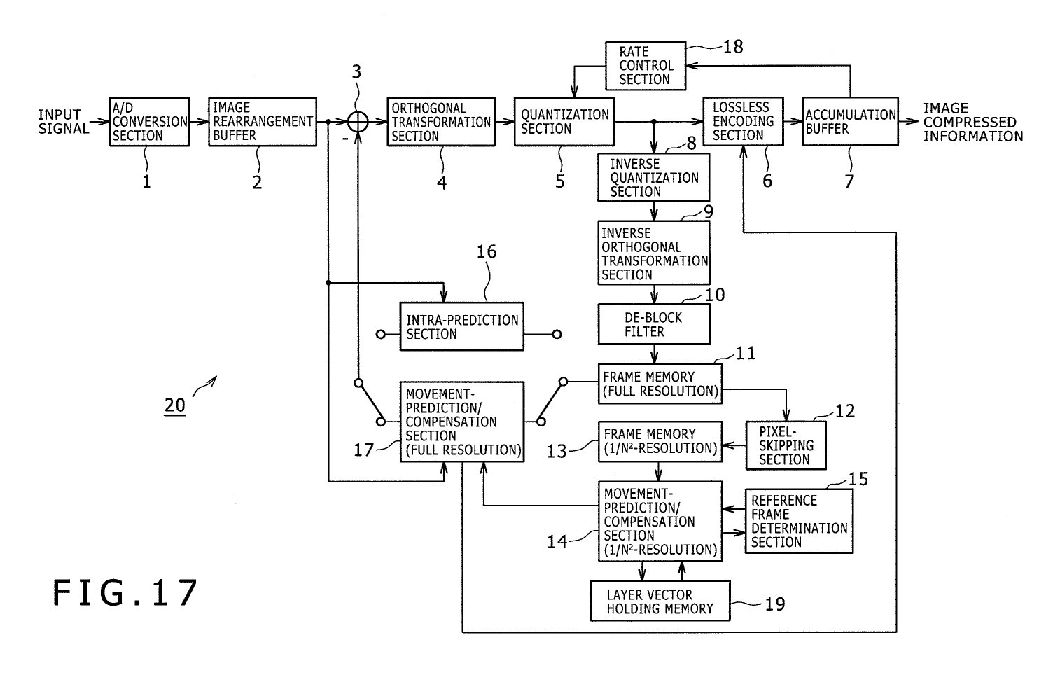

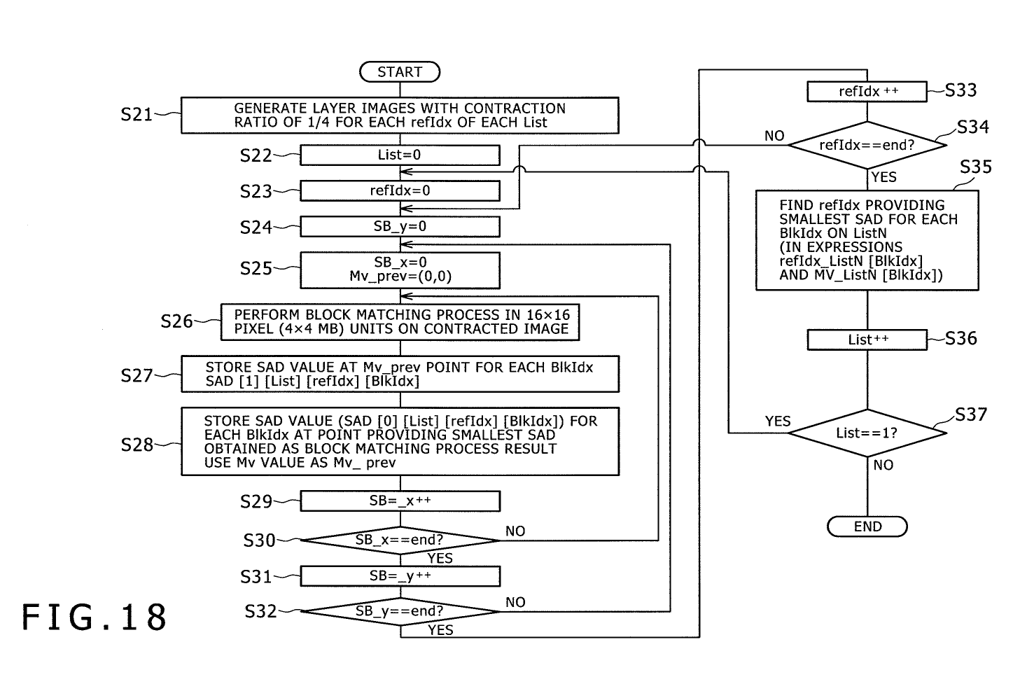

In addition, as another embodiment, it is possible to incorporate a later-vector holding memory 19 to be described later in the image-information coding apparatus 20 for generating image compressed information by adoption of an image coding method such as the AVC encoding system as shown in a block diagram of FIG. 17. With such a configuration, the image processing is carried out in accordance with a procedure represented by a flowchart shown in FIG. 18.

The flowchart begins with a step S21 at which the pixel skipping section 12 reads out image information from the full-resolution frame memory 11 and carries out a 1/N pixel skipping process in both the horizontal and vertical directions on the image information in order to generate pixel values which are then stored in the 1/N²-resolution frame memory 13.

Then, at the next step S22, the list number N is set at 0 (List0 is used as ListN).

Subsequently, at the next step S23, the index refIdx is set at 0 (refIdx=0).

Then, at the next step S24, the Y address of a superblock SB is reset (SB_y=0).

Subsequently, at the next step S25, the X address of the superblock SB is reset (SB_x=0). The reset X and Y addresses represent a left end location at which a movement vector Mv_Prev (a movement vector Mv on the left side) does not exist. Thus, the movement vector Mv_Prev is also reset.

Then, at the next step S26, the 1/N²-resolution movement-prediction/compensation section 14 carries out a block matching process by making use of pixel values stored in the 1/N²-resolution frame memory 13 as pixel values of the blocks in order to search for optimum movement vector information for the matching blocks.

Subsequently, at the next step S27, an SAD value computed during the process carried out at the step S26 to search for movement vector information as the SAD value associated with a movement vector Mv_Prev is stored for each value of the index BlkIdx.

Then, at the next step S28, an SAD value for a best point included in 4×4 MB as a point providing a smallest SAD value obtained as a result of the block matching process is stored for each value of the index BlkIdx. The Mv value found at that time is stored in the layer-vector holding memory 19 as the movement vector Mv_Prev.

Subsequently, at the next step S29, the X address of the superblock SB is incremented by 1. Then, the flow of the processing goes on to the next step S30 in order to produce a result of determination as to whether or not the X address of the superblock SB has reached the end X address. If the determination result is NO, the flow of the processing goes back to the step S26. If the determination result is YES, on the other hand, the flow of the processing goes on to a step S31 at which the Y address of the superblock SB is incremented by 1.

Then, the flow of the processing goes on to the next step S32 in order to produce a result of determination as to whether or not the Y address of the superblock SB has reached the end Y address. If the determination result is NO, the flow of the processing goes back to the step S25. If the determination result is YES, on the other hand, the flow of the processing goes on to a step S33 at which the index refIdx is incremented by 1.

Subsequently, the flow of the processing goes on to a step S34 in order to produce a result of determination as to whether or not the index refIdx has become equal to its maximum value. If the determination result is NO, the flow of the processing goes back to the step S24 in order to repeat the processes of the step S24 to S34.

If the determination result produced in the process carried out at the step S34 is YES, on the other hand, the flow of the processing goes on to a step S35 at which an index refIdx providing a smallest SAD is found for every value of the index BlkIdx of ListN.

Then, at the next step S36, the list number N is incremented by 1.

Subsequently, the flow of the processing goes on to a step S37 in order to produce a result of determination as to whether or not the list number N is equal to 1 indicating that the list is List1. If the determination result is YES, the flow of the processing goes back to the step S23 in order to repeat the processes of the step S23 to S37. If the determination result is NO, on the other hand, the processing represented by this flowchart is ended.

It should be understood by those skilled in the art that a variety of modifications, combinations, sub-combinations and alterations may occur, depending on design requirements and other factors as far as they are within the scope of the appended claims or the equivalents thereof.

What is claimed is:

1. A movement-prediction/compensation method for carrying out processing based on search layers to search for a movement vector by selecting a reference frame image including a reference block associated with one of movement-compensated blocks obtained as a result of dividing a processed frame image existing among successive frame images or by selecting two or more reference frame images each including such a reference block among a plurality of reference frame images for each of the movement-compensated blocks, the movement-prediction/compensation method comprising:
a layer creation step of generating a contracted image at a contraction ratio determined in advance on a low-level search layer by carrying out a pixel skipping process on pixels of the movement-compensated block with a largest pixel size deserving a position on the uppermost-level search layer among pixel sizes of the movement-compensated blocks;
a first movement-prediction/compensation step of searching for a movement vector by making use of the contracted image generated at the layer creation step;
a reference frame image determination step of determining a contracted reference image on the contracted image, the contracted reference image being used at the first movement-prediction/compensation step; and
a second movement-prediction/compensation step of carrying out a movement prediction process for a prior-contraction image by searching for a movement vector through use of a predetermined range specified by the movement vector found at the first movement-prediction/compensation step,
wherein, on the assumption that the unit of the layer search processing consists of M×N macro-blocks, at the first movement-prediction/compensation step,
every layer search processing unit consisting of M×N macro-blocks is divided into sub-units each consisting of M′×N′ macro-blocks where M′ is in the range between 1 and M whereas N′ is in the range between 1 and N,
an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit, and
a result of the block matching process for search point (0, 0) is also saved.

2. The movement-prediction/compensation method according to claim 1 wherein, at the reference frame image determination step, an energy-magnitude comparison process is carried out on a layer search optimum point and each arbitrary point for every sub-unit consisting of M′×N′ blocks in order to change a movement vector.

3. The movement-prediction/compensation method according to claim 1 wherein, at the reference frame image determination step, for every sub-unit consisting of M′×N′ blocks on each reference frame image, an energy-magnitude comparison process is carried out in order to change a reference frame image and a movement vector.

4. The movement-prediction/compensation method according to claim 1 wherein, at the reference frame image determination step, if an evaluation figure value for any individual one of the divided movement-compensated blocks is equal to an evaluation figure value for a corresponding reference block on each of reference frame images, a reference frame image indicated by a smallest index refIdx is selected for the individual movement-compensated block.

5. The movement-prediction/compensation method according to claim 1 wherein, on the assumption that the unit of the layer search processing consists of M×N macro-blocks, at the first movement-prediction/compensation step:
every layer search processing unit consisting of M×N macro-blocks is divided into sub-units each consisting of M′×N′ macro-blocks where M′ is in the range between 1 and M whereas N′ is in the range between 1 and N; and
an SATD (Sum of Absolute orthogonally Transformed Differences) is obtained and saved for each sub-unit, which consists of M′×N′ macro-blocks, of a layer search processing unit consisting of M×N macro-blocks as a result of a block matching process carried out on the layer search processing unit.

6. The movement-prediction/compensation method according to claim 1 wherein, on the assumption that the unit of the layer search processing consists of M×N macro-blocks, at the first movement-prediction/compensation step:
every layer search processing unit consisting of M×N macro-blocks is divided into sub-units each consisting of M′×N′ macro-blocks where M′ is in the range between 1 and M whereas N′ is in the range between 1 and N; and
an SSD (Sum of Squared Differences) is obtained and saved for each sub-unit, which consists of M′×N′ macro-blocks, of a layer search processing unit consisting of M×N macro-blocks as a result of a block matching process carried out on the layer search processing unit.

7. The movement-prediction/compensation method according to claim 1 wherein, at the reference frame image determination step, a sum of arbitrarily weighted values of an index refIdx indicating a reference frame image is also used as an evaluation figure value besides an evaluation figure value computed from results of a block matching process.

8. The movement-prediction/compensation method according to claim 1 wherein, on the assumption that the unit of the layer search processing consists of M×N macro-blocks, at the first movement-prediction/compensation step:
every layer search processing unit consisting of M×N macro-blocks is divided into sub-units each consisting of M′×N′ macro-blocks where M′ is in the range between 1 and M whereas N′ is in the range between 1 and N;
an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit; and
a search process result for any set point is also saved along with a search process result for search point (0, 0).

9. A movement-prediction/compensation apparatus for carrying out processing based on layer search layers to search for a movement vector by selecting a reference frame image including a reference block associated with one of movement-compensated blocks obtained as a result of dividing a processed frame image existing among successive frame images or by selecting two or more reference frame images each including such a reference block among a plurality of reference frame images for each of the movement-compensated blocks, the movement-prediction/compensation apparatus comprising:
layer creation means for generating a contracted image at a contraction ratio determined in advance on a low-level search layer by carrying out a pixel skipping process on pixels of the movement-compensated block with a largest pixel size deserving a position on the uppermost-level search layer among pixel sizes of the movement-compensated blocks;
first movement-prediction/compensation means for searching for a movement vector by making use of the contracted image generated by the layer creation means;
reference frame image determination means for determining a contracted reference image on the contracted image, the contracted reference image being used at the first movement-prediction/compensation means; and
second movement-prediction/compensation means for carrying out a movement prediction process for a prior-contraction image by searching for a movement vector through use of a predetermined range specified by the movement vector found by the first movement-prediction/compensation means,
wherein, on the assumption that the unit of the layer search processing consists of M×N macro-blocks, in the first movement-prediction/compensation means,
every layer search processing unit consisting of M×N macro-blocks is divided into sub-units each consisting of M′×N′ macro-blocks where M′ is in the range between 1 and M whereas N′ is in the range between 1 and N,
an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit, and
a result of the block matching process for search point (0, 0) is also saved.

10. The movement-prediction/compensation apparatus according to claim 9 wherein, in the reference frame image determination means, an energy-magnitude comparison process is carried out on a layer search optimum point and each arbitrary point for every sub-unit consisting of M′×N′ blocks in order to change a movement vector.

11. The movement-prediction/compensation apparatus according to claim 10 wherein, in the reference frame image determination means, for every sub-unit consisting of M′×N′ blocks on each reference frame image, an energy-magnitude comparison process is carried out in order to change a reference frame image and a movement vector.

12. The movement-prediction/compensation apparatus according to claim 10 wherein, in the reference frame image determination means, if an evaluation figure value for any individual one of the divided movement-compensated blocks is equal to an evaluation figure value for a corresponding reference block on each of the reference frame images, a reference frame image indicated by a smallest index refIdx is selected for the individual movement-compensated block.

13. The movement-prediction/compensation apparatus according to claim 9 wherein, on the assumption that the unit of the layer search processing consists of M×N macro-blocks, in the first movement-prediction/compensation means:
every layer search processing unit consisting of M×N macro-blocks is divided into sub-units each consisting of M′×N′ macro-blocks where M′ is in the range between 1 and M whereas N′ is in the range between 1 and N; and
an SATD (Sum of Absolute orthogonally Transformed Differences) is obtained and saved for each sub-unit, which consists of M′×N′ macro-blocks, of a layer search processing unit consisting of M×N macro-blocks as a result of a block matching process carried out on the layer search processing unit.

14. The movement-prediction/compensation apparatus according to claim 9 wherein, on the assumption that the unit of the layer search processing consists of M×N macro-blocks, in the first movement-prediction/compensation means:
every layer search processing unit consisting of M×N macro-blocks is divided into sub-units each consisting of M′×N′ macro-blocks where M′ is in the range between 1 and M whereas N′ is in the range between 1 and N; and
an SSD (Sum of Squared Differences) is obtained and saved for each sub-unit, which consists of M′×N′ macro-blocks, of a layer search processing unit consisting of M×N macro-blocks as a result of a block matching process carried out on the layer search processing unit.

15. The movement-prediction/compensation apparatus according to claim 9 wherein, in the reference frame image determination means, typically, a sum of arbitrarily weighted values of an index refIdx indicating a reference frame image is also used as an evaluation figure value besides an evaluation figure value computed from results of a block matching process.

16. The movement-prediction/compensation apparatus according to claim 9 wherein, on the assumption that the unit of the layer search processing consists of M×N macro-blocks, in the first movement-prediction/compensation means:
every layer search processing unit consisting of M×N macro-blocks is divided into sub-units each consisting of M′×N′ macro-blocks where M′ is in the range between 1 and M whereas N′ is in the range between 1 and N;
an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit; and
a search process result for any set point is also saved along with a search process result for search point (0, 0).

17. A movement-prediction/compensation apparatus for carrying out processing based on layer search layers to search for a movement vector by selecting a reference frame image including a reference block associated with one of movement-compensated blocks obtained as a result of dividing a processed frame image existing among successive frame images or by selecting two or more reference frame images each including such a reference block among a plurality of reference frame images for each of the movement-compensated blocks, the movement-prediction/compensation apparatus comprising:
a layer creation section configured to generate a contracted image at a contraction ratio determined in advance on a low-level search layer by carrying out a pixel skipping process on pixels of the movement-compensated block with a largest pixel size deserving a position on the uppermost-level search layer among pixel sizes of the movement-compensated blocks;
a first movement-prediction/compensation section configured to search for a movement vector by making use of the contracted image generated by the layer creation section;
a reference frame image determination section configured to determine a contracted reference image on the contracted image, the contracted reference image being used at the first movement-prediction/compensation section; and
a second movement-prediction/compensation section configured to carry out a movement prediction process for a prior-contraction image by searching for a movement vector through use of a predetermined range specified by the movement vector found by the first movement-prediction/compensation section,
wherein, on the assumption that the unit of the layer search processing consists of M×N macro-blocks, in the first movement-prediction/compensation section,
every layer search processing unit consisting of M×N macro-blocks is divided into sub-units each consisting of M′×N′ macro-blocks where M′ is in the range between 1 and M whereas N′ is in the range between 1 and N,
an SAD (Sum of Absolute Differences) is obtained and saved for each sub-unit, which consists of M′×N′ macro-blocks, of a layer search processing unit consisting of M×N macro-blocks as a result of a block matching process carried out on the layer search processing unit, and
a result of the block matching process for search point (0, 0) is also saved.
